(19) United States
(12) Patent Application Publication
(10) Pub. No.: US 2025/0305801 A1
(43) Pub. Date: Oct. 2, 2025

(54) ROBOTIC THREAT MITIGATION DEVICE

(71) Applicant: Ghaleb Ayed, Columbus, OH (US)

(72) Inventor: Ghaleb Ayed, Columbus, OH (US)

(21) Appl. No.: 18/624,964

(22) Filed: Apr. 2, 2024

(51) Int. Cl. F41H 13/00; B25J 9/16; B25J 11/00; F41A 27/28; F42B 12/54; F42B 12/72; H04N 7/18; H04R 1/02

(52) U.S. Cl. CPC F41H 13/00; B25J 9/1664; B25J 9/1689; B25J 11/002; F41A 27/28; H04N 7/183; F42B 12/54; F42B 12/72; H04R 1/025

(57) ABSTRACT

A robotic threat mitigation device includes a control unit that is positionable in a law enforcement agency. A swivel mount is mounted to a ceiling of a room and the swivel mount is in remote communication with the control unit for being remotely controlled by a law enforcement officer. An arm is pivotally attached to the swivel mount to point the arm toward any location in the room. The arm is in remote communication with the control unit for being remotely controlled by the law enforcement officer. A gun is attached to the communication unit thereby facilitating the gun to be aimed by the swivel mount and the arm. The gun can fire a first projectile or a second projectile to shoot the potential assailant.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to threat mitigation devices and more particularly pertains to a new threat mitigation device for remotely negotiating with and incapacitating an assailant. The device includes a swivel mount which is mounted to a ceiling and an arm that is pivotally attached to the swivel mount. Each of the swivel mount and the arm are in remote communication with a control unit that is located at a law enforcement agency. The device includes a gun that is attached to the arm which can fire a first projectile or a second projectile. Additionally, the gun is in remote communication with the control unit to facilitate the law enforcement officer to remotely fire the gun.

### (2) Description of Related Art Including Information Disclosed Under 37 CFR 1.97 and 1.98

The prior art relates to threat mitigation devices including a variety of remotely controlled weapon devices that each at least includes a remotely controlled vehicle and a remotely controlled swivel mount integrated into the remotely controlled vehicle and a weapon attached to the remotely controlled swivel mount and a variety of remotely controlled weapon devices that each at least includes a remotely controlled pivoting mount and a weapon that is attached to the remotely controlled pivoting mount. In no instance does the prior art disclose a robotic threat mitigation device that includes a swivel mount that is mounted to a ceiling of a room and an arm which is movably integrated into the swivel mount and a gun that is attached to the arm which can fire a first projectile or a second projectile and a control unit that is located at a law enforcement agency for remotely controlling the swivel mount and the arm and the gun.

### BRIEF SUMMARY OF THE INVENTION

An embodiment of the disclosure meets the needs presented above by generally comprising a control unit that is positionable in a law enforcement agency. A swivel mount is mounted to a ceiling of a room and the swivel mount is in remote communication with the control unit for being remotely controlled by a law enforcement officer. An arm is pivotally attached to the swivel mount to point the arm toward any location in the room. The arm is in remote communication with the control unit for being remotely controlled by the law enforcement officer. A gun is attached to the communication unit thereby facilitating the gun to be aimed by the swivel mount and the arm. The gun can fire a first projectile or a second projectile to shoot the potential assailant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a robotic threat mitigation device according to an embodiment of the disclosure.

FIG. 2 is a top view of an embodiment of the disclosure.

FIG. 3 is a front view of an embodiment of the disclosure.

FIG. 4 is a phantom perspective view of an embodiment of the disclosure.

FIG. 5 is a schematic view of an embodiment of the disclosure.

FIG. 6 is a perspective in-use view of an embodiment of the disclosure.

FIG. 7 is a phantom view of an embodiment of the disclosure.

### DETAILED DESCRIPTION OF THE INVENTION

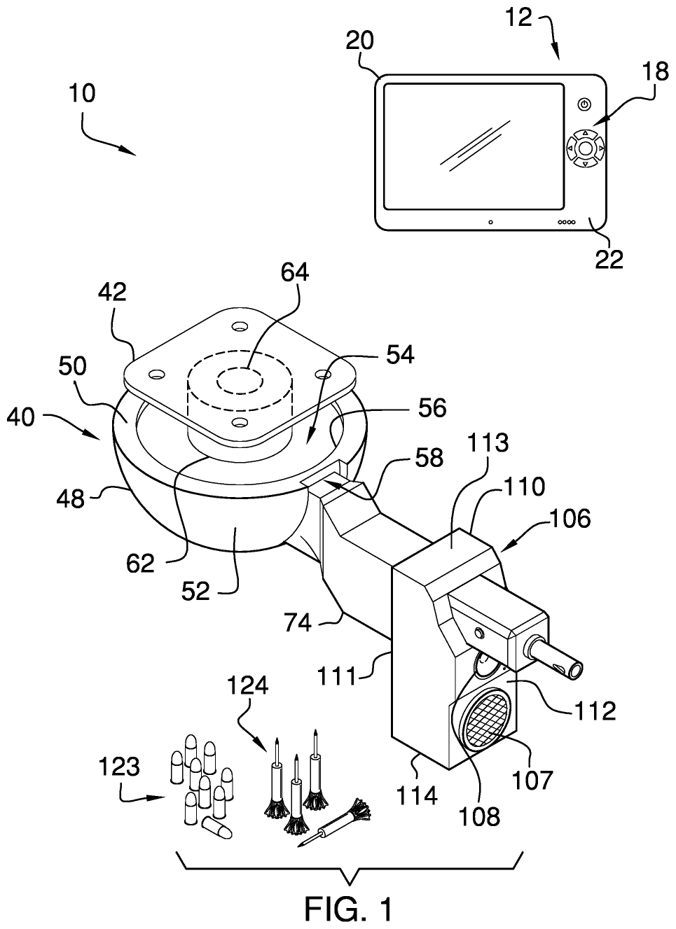

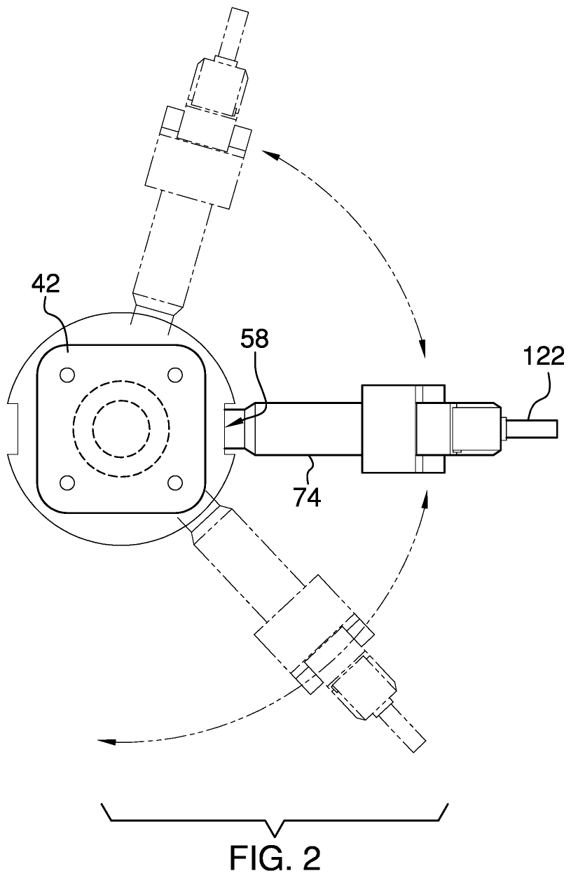

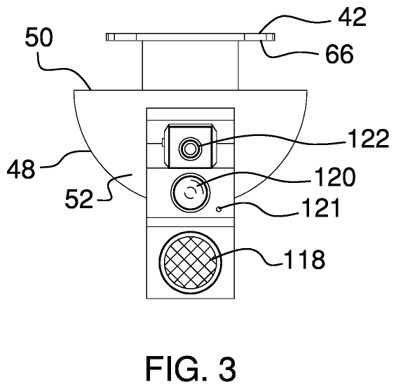

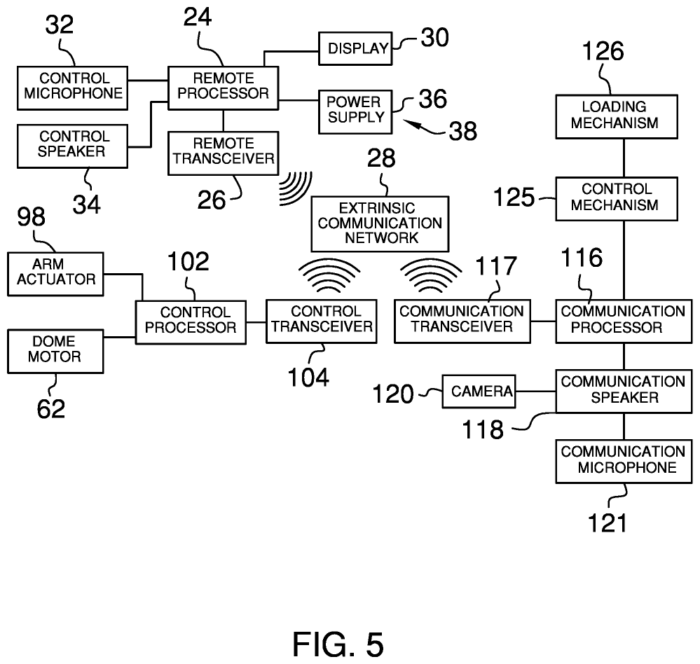

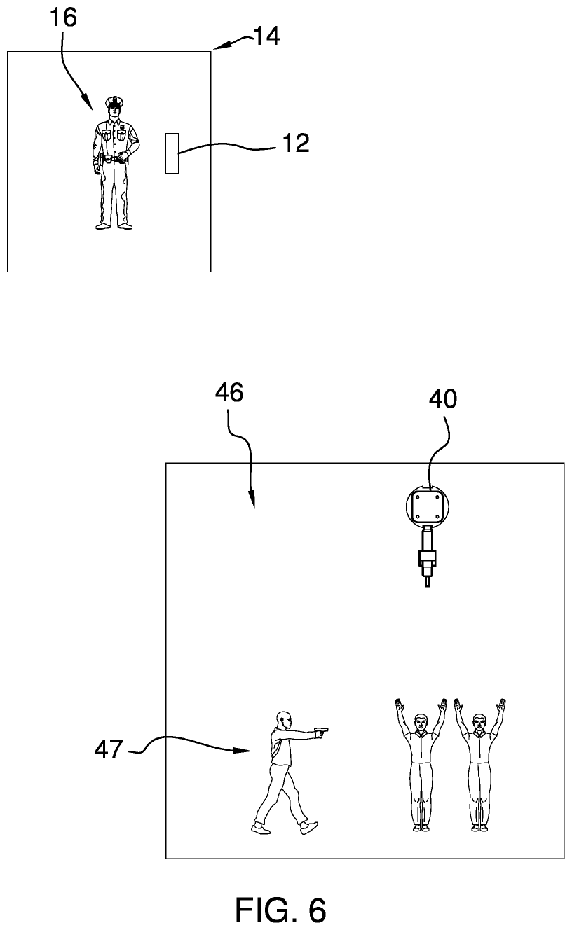

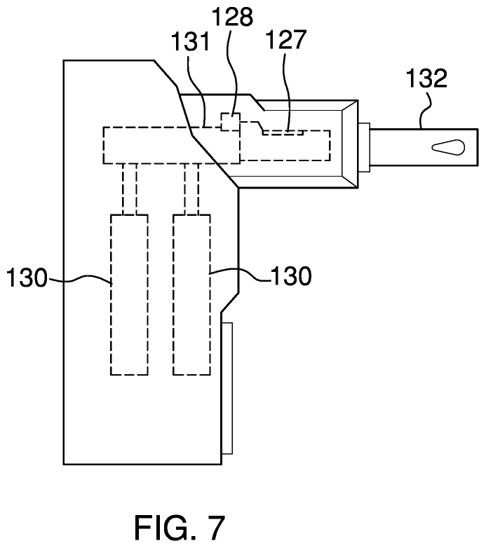

With reference now to the drawings, and in particular to FIGS. 1 through 7 thereof, a new threat mitigation device embodying the principles and concepts of an embodiment of the disclosure and generally designated by the reference numeral 10 will be described.

As best illustrated in FIGS. 1 through 7, the robotic threat mitigation device 10 generally comprises a control unit 12 is positionable in a law enforcement agency 14 such that the control unit 12 is accessible to a law enforcement officer 16. The law enforcement agency 14 may be a police department and the law enforcement officer 16 may be a police officer assigned to the police department. The control unit 12 includes an input control 18 that is movably integrated into the control unit 12 and the input control 18 can be manipulated by the law enforcement officer 16. The control unit 12 comprises a control housing 20 that has a front wall 22 and a remote processor 24 which is integrated into the control housing 20. The control unit 12 includes a remote transceiver 26 which is integrated into the control housing 20 and the remote transceiver 26 is electrically coupled to the remote processor 24. The remote transceiver 26 may comprise a radio frequency transceiver or the like and the remote transceiver 26 may be in wireless communication with an extrinsic communication network 28, such as the internet or a cellular phone network or other type of wireless communication network that facilitates nationwide data transmission.

The control unit 12 includes a display 30 that is integrated into the front wall 22 of the control housing 20 such that the display 30 is visible to the law enforcement officer 16 and the display 30 is electrically coupled to the remote processor 24. The display 30 may comprise a light emitting diode display or other type of electronic display. The control unit 12 includes a control microphone 32 that is integrated into the control housing 20 such that the control microphone 32 can sense audible sounds and the control microphone 32 is electrically coupled to the remote processor 24. The control unit 12 includes a control speaker 34 that is integrated into the control housing 20 to emit audible sounds outwardly from the control housing 20 and the control speaker 34 is electrically coupled to the remote processor 24.

The input control 18 is movably integrated into the front wall 22 of the control housing 20 and the input control 18 is electrically coupled to the remote processor 24. The input control 18 may comprise a directional pad, a joystick or other type of electronic directional control commonly employed with remote control devices. Furthermore, the remote transceiver 26 broadcasts directional commands received from the input control 18. The control unit 12 includes a power supply 36 that is integrated into the control housing 20. The power supply 36 is electrically coupled to the remote processor 24 and the power supply 36 comprises at least one battery 38.

A swivel mount 40 is included which has a planar mounting plate 42 which can be mounted to a ceiling 44 of a room 46. The room 46 may be located in a public building, including but not being limited to, a public school or a retail store or any other location that could potentially be overtaken by an assailant 47. The swivel mount 40 is actuatable to rotate 360.0 degrees in a first direction or 360.0 degrees in a second direction. Additionally, the swivel mount 40 is in remote communication with the control unit 12 such that the swivel mount 40 can be remotely controlled by the law enforcement officer 16.

The swivel mount 40 comprises a dome 48 which has an upper side 50 and a lower side 52; the lower side 52 is rounded and the upper side 50 is planar. The dome 48 has a depression 54 extending downwardly into the upper side 50 and the depression 54 has a bounding surface 56 which is spaced from and is coextensive with an intersection between the upper side 50 and the lower side 52 such that the depression 54 has a circular shape. The dome 48 has a slot 58 extending into an interior of the dome 48 and the slot 58 extends from the intersection between the upper side 50 and the lower side 52 and an apex 60 of the lower side 52.

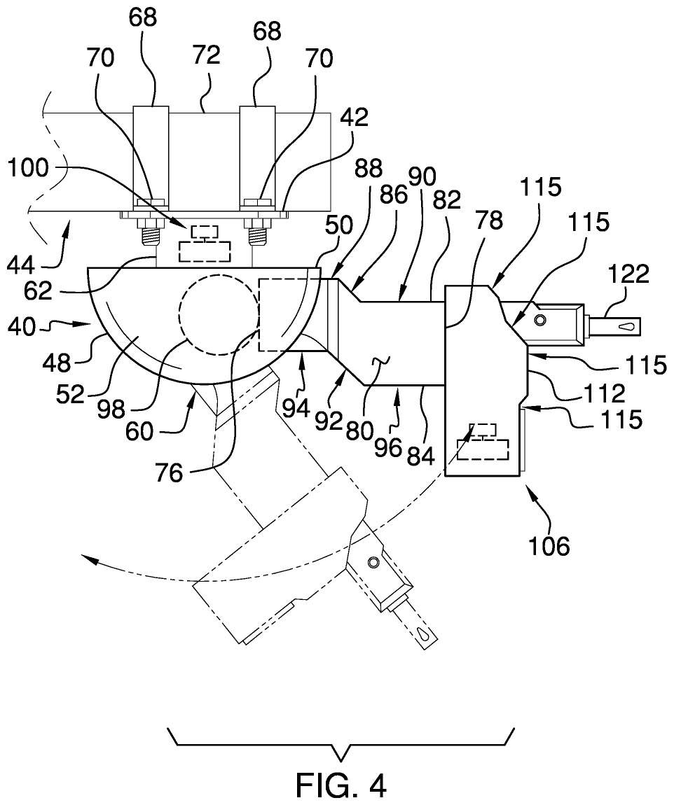

The swivel mount 40 includes a dome motor 62 that is attached to the upper side 50 and the dome motor 62 is centrally located in the depression 54 in the upper side 50. The dome motor 62 has an output shaft 64 that is rotatable in a first direction or a second direction when the dome motor 62 is actuated to rotate in a first direction or a second direction. Additionally, the output shaft 64 is attached to a bottom surface 66 of the planar mounting plate 42 thereby facilitating the dome 48 to be rotated on the mounting plate 42. The dome motor 62 may comprise a two direction electric motor or other type of actuator that can generate rotational torque in two directions. As is shown in FIG. 4, a pair of brackets 68 and fasteners 70 may be provided for fastening the planar mounting plate 42 to a joist 72 in the ceiling 44.

An arm 74 is pivotally attached to the swivel mount 40 and the arm 74 is actuatable to pivot in a first direction or a second direction. In this way the arm 74 and the swivel mount 40 can point the arm 74 toward any location in the room 46. The arm 74 is in remote communication with the control unit 12 such that the arm 74 can be remotely controlled by the law enforcement officer 16. The arm 74 has a first end 76 and a second end 78 and an outer surface 80 extending between the first end 76 and the second end 78 and the outer surface 80 has a top side 82 and a bottom side 84. The top side 82 has a middle section 86 sloping downwardly between a rear section 88 and a forward section 90. The rear section 88 is associated with the first end 76 and the forward section 90 is associated with the second end 78. The bottom side 84 has a central section 92 sloping downwardly between a back section 94 and a front section 96. The back section 94 is oriented parallel with the rear section 88 and the central section 92 is oriented parallel with the middle section 86 and the front section 96 is oriented parallel with the forward section 90. Furthermore, the arm 74 extends into the slot 58 in the lower side 52 of the dome 48 such that the first end 76 is positioned inside of the dome 48.

An arm actuator 98 is disposed within the dome 48 and the arm actuator 98 is actuatable into a lowering condition or a lifting condition. Additionally, the first end 76 of the arm 74 is attached to the arm actuator 98. The arm 74 travels toward the apex 60 of the lower side 52 of the dome 48 when the actuator is actuated into the lowering condition. Conversely, the arm 74 travels toward the intersection between the lower side 52 of the dome 48 and the upper side 50 of the dome 48 when the arm actuator 98 is actuated into the lifting condition. The arm actuator 98 may comprise a two direction electric motor and a gear drive that engages the first end 76 of the arm 74 or other type of electromechanical actuator that can pivot the arm 74 upwardly or downwardly.

A movement control 100 is integrated into the swivel mount 40 and the movement control 100 is in communication with each of the swivel mount 40 and the arm 74 for controlling movement of each of the swivel mount 40 and the arm 74. The movement control 100 comprises a control processor 102 that is integrated into the dome motor 62 and the control processor 102 is electrically coupled to each of the dome motor 62 and the arm actuator 98. Furthermore, the control processor 102 is electrically coupled to a power source 103 comprising an electrical system of the room 46 in which the dome 48 and the arm 74 are positioned. The movement control 100 includes a control transceiver 104 which is integrated into the dome motor 62 and the control transceiver 104 is electrically coupled to the control processor 102. The control transceiver 104 is in wireless communication with the remote transceiver 26 thereby facilitating the control transceiver 104 to receive the directional commands from the remote transceiver 26 facilitating each of the dome motor 62 and the actuator to be remotely controlled. Additionally, the control transceiver 104 may comprise a radio frequency transceiver or the like and the control transceiver 104 may be in wireless communication with the extrinsic communication network 28 such that the control transceiver 104 can communicate with the remote transceiver 26 regardless of the distance between them.

A communication unit 106 is attached to the arm 74 and the communication unit 106 is in remote communication with the control unit 12. The communication unit 106 has a sound emitter 107 which can audibly emit words spoken by the law enforcement officer 16 thereby facilitating the law enforcement officer 16 to verbally communicate with a potential assailant 47 in the room 46. The communication unit 106 has a sound recorder 108 to receive audible sounds in the room 46 thereby facilitating the law enforcement officer 16 to hear the potential assailant 47. The communication unit 106 comprises a communication housing 110 which has a rear wall 111 and a forward wall 112 and a top wall 113 and a bottom wall 114. The rear wall 111 is attached to the second end 78 of the arm 74 at an attachment point that is located closer to the top wall 113 than the bottom wall 114. Additionally, the forward wall 112 has a plurality of intersecting sides 115 which are oriented at angles with each other such that a profile of the forward wall 112 defines a polygonal chain.

The communication unit 106 includes a communication processor 116 which is integrated into the communication housing 110 and a communication transceiver 117 that is integrated into the communication housing 110. The communication transceiver 117 is electrically coupled to the communication processor 116 and the communication transceiver 117 is in wireless communication with the remote transceiver 26. Furthermore, the communication transceiver 117 may comprise a radio frequency transceiver or the like and the communication transceiver 117 may be in wireless communication with the extrinsic communication network 28 thereby facilitating the communication transceiver 117 to communicate with the remote transceiver 26 regardless of the distance between them.

The communication unit 106 includes a communication speaker 118 that is integrated into the forward wall 112 of the communication housing 110 such that the communication speaker 118 defines the sound emitter 107 of the communication unit 106. The communication speaker 118 is electrically coupled to the communication processor 116 thereby facilitating the communication speaker 118 to receive audible sounds sensed by the control microphone 32 in the control housing 20 which are broadcast by the remote transceiver 26 to the communication transceiver 117. Additionally, the communication speaker 118 is disposed on a respective one of the plurality of intersecting sides 115 of the forward wall 112 which intersects the bottom wall 114 of the communication housing 110.

The communication unit 106 includes a camera 120 that is integrated into the forward wall 112 of the communication housing 110 thereby facilitating the camera 120 to capture imagery of the room 46. The camera 120 is electrically coupled to the communication processor 116 thereby facilitating the communication transceiver 117 to broadcast the imagery to the remote transceiver 26. In this way the display 30 on the control housing 20 facilitates the law enforcement officer 16 to view the imagery. The camera 120 is disposed on a respective one of the plurality of intersecting sides 115 of the forward wall 112 such that the camera 120 is positioned between the communication speaker 118 and the top wall 113 of the communication housing 110. Furthermore, the camera 120 may comprise a digital video camera and the camera 120 may include a lens that is integrated into the respective intersecting side of the forward wall.

The communication unit 106 includes a communication microphone 121 that is integrated into the forward wall 112 of the communication housing 110 to sense audible sounds in the room 46. The communication microphone 121 is electrically coupled to the communication processor 116 thereby facilitating the communication transceiver 117 to broadcast the audible sounds captured by the communication microphone 121 to the remote transceiver 26. In this way the control speaker 34 in the control housing 20 can emit the audible sounds captured by the communication microphone 121 thereby facilitating the law enforcement officer 16 to hear words spoken by the potential assailant 47. The communication microphone 121 is disposed on the respective intersecting side 115 of the forward wall 112 on which the camera 120 is disposed and the communication microphone 121 may comprise an electronic microphone of any conventional design. The communication processor 116 may store a database which includes voice recognition software thereby facilitating audible sounds captured by the communication microphone 121 to be analyzed to detect fear or panic in occupants of the room 46 as well as to recognize words that would indicate that an assailant 47 has entered the room 46 with a gun, for example. Furthermore, the communication transceiver 117 may be actuated to contact the remote transceiver 26 when the voice recognition software determines that an assailant 47 has potentially entered the room 46. In this way the law enforcement officer 16 can be immediately notified of a potentially dangerous situation and initiate an appropriate response.

A gun 122 is attached to the communication unit 106 thereby facilitating the gun 122 to be aimed by the swivel mount 40 and the arm 74. In this way the gun 122 can be pointed toward the potential assailant 47. The gun 122 is actuatable into a first condition having the gun 122 firing a first projectile 123 to shoot the potential assailant 47 with the first projectile 123. Furthermore, the gun 122 is actuatable into a second condition having the gun 122 firing a second projectile 124 to shoot the potential assailant 47 with the second projectile 124. The first projectile 123 may comprise a non-lethal bullet of any conventional design, including but not being limited to rubber bullets and bean bags. Additionally, the second projectile 124 may comprise a drug injection dart or other type of projectile that can deliver a tranquilizer, for example, or other type of drug that can rapidly incapacitate the assailant 47.

The gun 122 has a control mechanism 125 that is electrically coupled to the communication processor 116 thereby facilitating the control mechanism 125 to receive a firing command from the remote transceiver 26. In this way the gun 122 can be remotely fired by the law enforcement officer 16. The control mechanism 125 may include a firing pin 127 and a trigger 128 and a plurality of actuators 129 for automatically actuating the trigger 128 and cycling the firing pin 127. Additionally, the gun 122 has a loading mechanism 126 that is electrically coupled to the communication processor 116 and the loading mechanism 126 contains each of the plurality of first projectiles 123 and each of the plurality of second projectiles 124. The loading mechanism 126 loads one of the plurality of first projectiles 123 into the gun 122 when the communication transceiver 117 receives a first projectile 123 command from the remote transceiver 26. In this way the loading mechanism 126 is facilitates the law enforcement officer 16 to remotely fire one of the plurality of first projectiles 123.

The loading mechanism 126 loads one of the plurality of second projectiles 124 into the gun 122 when the communication transceiver 117 receives a second projectile 124 command from the remote transceiver 26. In this way the loading mechanism 126 facilitates the law enforcement officer 16 to remotely fire one of the plurality of second projectiles 124. The loading mechanism 126 may include a pair of magazines 130 which each contain respective first projectiles 123 and second projectiles 124 and the loading mechanism 126 may include a receiver 131 that includes electromechanical actuators for automatically loading the first projectiles 123 and the second projectiles 124 into a barrel 132 of the gun 122. The gun 122 extends away from the forward wall 112 of the communication housing 110 and the gun 122 is disposed on a respective one of the plurality of intersecting sides 115 of the forward wall 112 which intersects the top wall 113 of the communication housing 110.

In use, the law enforcement officer 16 controls the swivel mount 40 and the arm 74 in the event that a potential assailant 47 has entered the room 46 in which the swivel mount 40 and the arm 74 are located. The camera 120 facilitates the law enforcement officer 16 to view the room 46 and the communication speaker 118 and communication microphone 121 facilitate the law enforcement officer 16 to verbally communicate with the potential assailant 47. The law enforcement officer 16 can choose to load either a first projectile 123 or a second projectile 124 into the gun 122, depending upon which the law enforcement officer 16 feels would be most effective or appropriate. Furthermore, the law enforcement officer 16 can fire the gun 122 at the potential assailant 47 as many times as necessary in order to incapacitate the potential assailant 47. In this way the law enforcement officer 16 can negotiate with the potential assailant 47 and incapacitate the potential assailant 47 without exposing themselves to the risk of harm 74.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A robotic threat mitigation device for facilitating law enforcement to remotely communicate with and neutralize a potential assailant, said device comprising:
a control unit being positionable in a law enforcement agency wherein said control unit is configured to be accessible to a law enforcement officer, said control unit including an input control being movably integrated into said control unit wherein said input control is configured to be manipulated by the law enforcement officer;
a swivel mount having a planar mounting plate wherein said planar mounting plate is configured to be mounted to a ceiling of a room, said swivel mount being actuatable to rotate 360.0 degrees in a first direction or 360.0 degrees in a second direction, said swivel mount being in remote communication with said control unit wherein said swivel mount is configured to be remotely controlled by the law enforcement officer;
an arm being pivotally attached to said swivel mount, said arm being actuatable to pivot in a first direction or a second direction wherein said arm and said swivel mount are configured to point said arm toward any location in the room, said arm being in remote communication with said control unit wherein said arm is configured to be remotely controlled by the law enforcement officer;
a movement control being integrated into said swivel mount, said movement control being in communication with each of said swivel mount and said arm for controlling movement of each of said swivel mount and said arm;
a communication unit being attached to said arm, said communication unit being in remote communication with said control unit, said communication unit having a sound emitter wherein said sound emitter is configured to audibly emit words spoken by the law enforcement officer thereby facilitating the law enforcement officer to verbally communicate with a potential assailant in the room, said communication unit having a sound recorder wherein said sound recorder is configured to receive audible sounds in the room thereby facilitating the law enforcement officer to hear the potential assailant; and
a gun being attached to said communication unit thereby facilitating said gun to be aimed by said swivel mount and said arm wherein said gun is configured to be pointed toward the potential assailant, said gun being actuatable into a first condition having said gun firing a first projectile wherein said gun is configured to shoot the potential assailant with said first projectile, said gun being actuatable into a second condition having said gun firing a second projectile wherein said gun is configured to shoot the potential assailant with said second projectile.

2. The device according to claim 1, wherein:
said control unit comprises a control housing having a front wall;
said control unit comprises a remote processor being integrated into said control housing;
said control unit comprises a remote transceiver being integrated into said control housing, said remote transceiver being electrically coupled to said remote processor;
said control unit comprises a display being integrated into said front wall of said control housing wherein said display is configured to be visible to the law enforcement officer, said display being electrically coupled to said remote processor;
said control unit comprises a control microphone being integrated into said control housing wherein said control microphone is configured to sense audible sounds, said control microphone being electrically coupled to said remote processor;
said control unit comprises a control speaker being integrated into said control housing wherein said control speaker is configured to emit audible sounds outwardly from said control housing, said control speaker being electrically coupled to said remote processor;
wherein said input control is movably integrated into said front wall of said control housing, said input control being electrically coupled to said remote processor, said remote transceiver broadcasting directional commands received from said input control; and
said control unit comprises a power supply being integrated into said control housing, said power supply being electrically coupled to said remote processor, said power supply comprising at least one battery.

3. The device according to claim 1, wherein:
said swivel mount comprises a dome having an upper side and a lower side;
said lower side being rounded and said upper side being planar;
said dome has a depression extending downwardly into said upper side;
said depression has a bounding surface being spaced from and being coextensive with an intersection between said upper side and said lower side such that said depression has a circular shape;
said dome has a slot extending into an interior of said dome;
said slot extends from said intersection between said upper side and said lower side and an apex of said lower side;
said swivel mount comprises a dome motor being attached to said upper side having said dome motor being centrally located in said depression in said upper side;
said dome motor has an output shaft being rotatable in a first direction or a second direction when said dome motor is actuated to rotate in a first direction or a second direction; and
said output shaft is attached to a bottom surface of said planar mounting plate thereby facilitating said dome to be rotated on said mounting plate.

4. The device according to claim 3, wherein:
said arm has a first end and a second end and an outer surface extending between said first end and said second end;
said outer surface has a top side and a bottom side;
said top side has a middle section sloping downwardly between a rear section and a forward section;
said rear section is associated with said first end;
said forward section is associated with said second end;
said bottom side has a central section sloping downwardly between a back section and a front section;
said back section is oriented parallel with said rear section;
said central section is oriented parallel with said middle section;
said front section is oriented parallel with said forward section; and
said arm extends into said slot in said lower side of said dome such that said first end is positioned inside of said dome.

5. The device according to claim 3, wherein:
said device includes an arm actuator being disposed within said dome;
said arm actuator is actuatable into a lowering condition or a lifting condition;
said first end of said arm is attached to said arm actuator;
said arm travels toward said apex of said lower side of said dome when said actuator is actuated into said lowering condition; and
said arm travels toward said intersection between said lower side of said dome and said upper side of said dome when said arm actuator is actuated into said lifting condition.

6. The device according to claim 5, wherein:
said control unit includes a remote transceiver;
said movement control comprises a control processor being integrated into said dome motor;
said control processor is electrically coupled to each of said dome motor and said arm actuator;
said control processor is electrically coupled to a power source comprising an electrical system of the room in which said dome and said arm are positioned;
said movement control comprises a control transceiver being integrated into said dome motor;
said control transceiver is electrically coupled to said control processor; and
said control transceiver is in wireless communication with said remote transceiver thereby facilitating said control transceiver to receive said directional commands from said remote transceiver facilitating each of said dome motor and said actuator to be remotely controlled.

7. The device according to claim 4, wherein:
said control unit includes a remote transceiver;
said communication unit comprises a communication housing having a rear wall and a forward wall and a top wall and a bottom wall;
said rear wall is attached to said second end of said arm at an attachment point being located closer to said top wall than said bottom wall;
said forward wall has a plurality of intersecting sides being oriented at angles with each other such that a profile of said forward wall defines a polygonal chain;
said communication unit comprises a communication processor being integrated into said communication housing;
said communication unit comprises a communication transceiver being integrated into said communication housing;
said communication transceiver is electrically coupled to said communication processor; and
said communication transceiver is in wireless communication with said remote transceiver.

8. The device according to claim 7, wherein:
said control unit includes a control housing and a control microphone integrated into said control housing;
said communication unit includes a communication speaker being integrated into said forward wall of said communication housing such that said communication speaker defines said sound emitter of said communication unit;
said communication speaker is electrically coupled to said communication processor thereby facilitating said communication speaker to receive audible sounds sensed by said control microphone in said control housing which are broadcast by said remote transceiver to said communication transceiver; and
said communication speaker is disposed on a respective one of said plurality of intersecting sides of said forward wall which intersects said bottom wall of said communication housing.

9. The device according to claim 7, wherein:
said communication unit includes a camera being integrated into said forward wall of said communication housing thereby facilitating said camera to capture imagery of the room;
said camera is electrically coupled to said communication processor thereby facilitating said communication transceiver to broadcast said imagery to said remote transceiver wherein said display on said control housing is configured to facilitate the law enforcement officer to view said imagery;
said camera is disposed on a respective one of said plurality of intersecting sides of said forward wall such that said camera is positioned between said communication speaker and said top wall of said communication housing;
said communication unit includes a communication microphone being integrated into said forward wall of said communication housing wherein said communication microphone on said forward wall is configured to sense audible sounds in the room;
said communication microphone is electrically coupled to said communication processor thereby facilitating said communication transceiver to broadcast the audible sounds captured by said communication microphone to said remote transceiver wherein said control speaker in said control housing is configured to emit the audible sounds captured by said communication microphone thereby facilitating the law enforcement officer to hear words spoken by the potential assailant; and
said communication microphone is disposed on said respective intersecting side of said forward wall on which said camera is disposed.

10. The device according to claim 7, wherein:
said gun has a control mechanism being electrically coupled to said communication processor thereby facilitating said control mechanism to receive a firing command from said remote transceiver wherein said gun is configured to be remotely fired by the law enforcement officer;
said gun has a loading mechanism being electrically coupled to said communication processor; and
said loading mechanism contains each of said plurality of first projectiles and each of said plurality of second projectiles.

11. The device according to claim 10, wherein said loading mechanism loads one of said plurality of first projectiles into said gun when said communication transceiver receives a first projectile command from said remote transceiver wherein said loading mechanism is configured to facilitate the law enforcement officer to remotely fire one of said plurality of first projectiles.

12. The device according to claim 1, wherein said loading mechanism loads one of said plurality of second projectiles into said gun when said communication transceiver receives a second projectile command from said remote transceiver wherein said loading mechanism is configured to facilitating the law enforcement officer to remotely fire one of said plurality of second projectiles.

13. The device according to claim 7, wherein:
said gun extends away from said forward wall of said communication housing; and
said gun is disposed on a respective one of said plurality of intersecting sides of said forward wall which intersects said top wall of said communication housing.

14. A robotic threat mitigation device for facilitating law enforcement to remotely communicate with and neutralize a potential assailant, said device comprising:
a control unit being positionable in a law enforcement agency wherein said control unit is configured to be accessible to a law enforcement officer, said control unit including an input control being movably integrated into said control unit wherein said input control is configured to be manipulated by the law enforcement officer, said control unit comprising:
a control housing having a front wall;
a remote processor being integrated into said control housing;
a remote transceiver being integrated into said control housing, said remote transceiver being electrically coupled to said remote processor;
a display being integrated into said front wall of said control housing wherein said display is configured to be visible to the law enforcement officer, said display being electrically coupled to said remote processor;
a control microphone being integrated into said control housing wherein said control microphone is configured to sense audible sounds, said control microphone being electrically coupled to said remote processor;
a control speaker being integrated into said control housing wherein said control speaker is configured to emit audible sounds outwardly from said control housing, said control speaker being electrically coupled to said remote processor;
wherein said input control is movably integrated into said front wall of said control housing, said input control being electrically coupled to said remote processor, said remote transceiver broadcasting directional commands received from said input control; and
a power supply being integrated into said control housing, said power supply being electrically coupled to said remote processor, said power supply comprising at least one battery;
a swivel mount having a planar mounting plate wherein said planar mounting plate is configured to be mounted to a ceiling of a room, said swivel mount being actuatable to rotate 360.0 degrees in a first direction or 360.0 degrees in a second direction, said swivel mount being in remote communication with said control unit wherein said swivel mount is configured to be remotely controlled by the law enforcement officer, said swivel mount comprising:
a dome having an upper side and a lower side, said lower side being rounded and said upper side being planar, said dome having a depression extending downwardly into said upper side, said depression having a bounding surface being spaced from and being coextensive with an intersection between said upper side and said lower side such that said depression has a circular shape, said dome having a slot extending into an interior of said dome, said slot extending from said intersection between said upper side and said lower side and an apex of said lower side; and
a dome motor being attached to said upper side having said dome motor being centrally located in said depression in said upper side, said dome motor having an output shaft being rotatable in a first direction or a second direction when said dome motor is actuated to rotate in a first direction or a second direction, said output shaft being attached to a bottom surface of said planar mounting plate thereby facilitating said dome to be rotated on said mounting plate;
an arm being pivotally attached to said swivel mount, said arm being actuatable to pivot in a first direction or a second direction wherein said arm and said swivel mount are configured to point said arm toward any location in the room, said arm being in remote communication with said control unit wherein said arm is configured to be remotely controlled by the law enforcement officer, said arm having a first end and a second end and an outer surface extending between said first end and said second end, said outer surface having a top side and a bottom side, said top side having a middle section sloping downwardly between a rear section and a forward section, said rear section being associated with said first end, said forward section being associated with said second end, said bottom side having a central section sloping downwardly between a back section and a front section, said back section being oriented parallel with said rear section, said central section being oriented parallel with said middle section, said front section being oriented parallel with said forward section, said arm extending into said slot in said lower side of said dome such that said first end is positioned inside of said dome;
an arm actuator being disposed within said dome, said arm actuator being actuatable into a lowering condition or a lifting condition, said first end of said arm being attached to said arm actuator, said arm travelling toward said apex of said lower side of said dome when said actuator is actuated into said lowering condition, said arm travelling toward said intersection between said lower side of said dome and said upper side of said dome when said arm actuator is actuated into said lifting condition;
a movement control being integrated into said swivel mount, said movement control being in communication with each of said swivel mount and said arm for controlling movement of each of said swivel mount and said arm, said movement control comprising:
a control processor being integrated into said dome motor, said control processor being electrically coupled to each of said dome motor and said arm actuator, said control processor being electrically coupled to a power source comprising an electrical system of the room in which said dome and said arm are positioned; and
a control transceiver being integrated into said dome motor, said control transceiver being electrically coupled to said control processor, said control transceiver being in wireless communication with said remote transceiver thereby facilitating said control transceiver to receive said directional commands from said remote transceiver facilitating each of said dome motor and said actuator to be remotely controlled;
a communication unit being attached to said arm, said communication unit being in remote communication with said control unit, said communication unit having a sound emitter wherein said sound emitter is configured to audibly emit words spoken by the law enforcement officer thereby facilitating the law enforcement officer to verbally communicate with a potential assailant in the room, said communication unit having a sound recorder wherein said sound recorder is configured to receive audible sounds in the room thereby facilitating the law enforcement officer to hear the potential assailant, said communication unit comprising:
a communication housing having a rear wall and a forward wall and a top wall and a bottom wall, said rear wall being attached to said second end of said arm at an attachment point being located closer to said top wall than said bottom wall, said forward wall having a plurality of intersecting sides being oriented at angles with each other such that a profile of said forward wall defines a polygonal chain;
a communication processor being integrated into said communication housing;
a communication transceiver being integrated into said communication housing, said communication transceiver being electrically coupled to said communication processor, said communication transceiver being in wireless communication with said remote transceiver;
a communication speaker being integrated into said forward wall of said communication housing such that said communication speaker defines said sound emitter of said communication unit, said communication speaker being electrically coupled to said communication processor thereby facilitating said communication speaker to receive audible sounds sensed by said control microphone in said control housing which are broadcast by said remote transceiver to said communication transceiver, said communication speaker being disposed on a respective one of said plurality of intersecting sides of said forward wall which intersects said bottom wall of said communication housing;
a camera being integrated into said forward wall of said communication housing thereby facilitating said camera to capture imagery of the room, said camera being electrically coupled to said communication processor thereby facilitating said communication transceiver to broadcast said imagery to said remote transceiver wherein said display on said control housing is configured to facilitate the law enforcement officer to view said imagery, said camera being disposed on a respective one of said plurality of intersecting sides of said forward wall such that said camera is positioned between said communication speaker and said top wall of said communication housing;
a communication microphone being integrated into said forward wall of said communication housing wherein said communication microphone on said forward wall is configured to sense audible sounds in the room, said communication microphone defining said sound recorder, said communication microphone being electrically coupled to said communication processor thereby facilitating said communication transceiver to broadcast the audible sounds captured by said communication microphone to said remote transceiver wherein said control speaker in said control housing is configured to emit the audible sounds captured by said communication microphone thereby facilitating the law enforcement officer to hear words spoken by the potential assailant, said communication microphone being disposed on said respective intersecting side of said forward wall on which said camera is disposed; and
a gun being attached to said communication unit thereby facilitating said gun to be aimed by said swivel mount and said arm wherein said gun is configured to be pointed toward the potential assailant, said gun being actuatable into a first condition having said gun firing a first projectile wherein said gun is configured to shoot the potential assailant with said first projectile, said gun being actuatable into a second condition having said gun firing a second projectile wherein said gun is configured to shoot the potential assailant with said second projectile, said gun having a control mechanism being electrically coupled to said communication processor thereby facilitating said control mechanism to receive a firing command from said remote transceiver wherein said gun is configured to be remotely fired by the law enforcement officer, said gun having a loading mechanism being electrically coupled to said communication processor, said loading mechanism containing each of said plurality of first projectiles and each of said plurality of second projectiles, said loading mechanism loading one of said plurality of first projectiles into said gun when said communication transceiver receives a first projectile command from said remote transceiver wherein said loading mechanism is configured to facilitate the law enforcement officer to remotely fire one of said plurality of first projectiles, said loading mechanism loading one of said plurality of second projectiles into said gun when said communication transceiver receives a second projectile command from said remote transceiver wherein said loading mechanism is configured to facilitating the law enforcement officer to remotely fire one of said plurality of second projectiles, said gun extending away from said forward wall of said communication housing, said gun being disposed on a respective one of said plurality of intersecting sides of said forward wall which intersects said top wall of said communication housing.
